(19) United States
(12) Patent Application Publication
(10) Pub. No.: US 2026/0089141 A1
(43) Pub. Date: Mar. 26, 2026

(54) MEDIATION SYSTEMS AND METHODS FOR A FEDERATED CONFIDENTIAL COMPUTING ENVIRONMENT

(71) Applicant: GENXT LTD, Hinxton Cambridgeshire (GB)

(72) Inventors: Pavel NIKONOROV, Hinxton Cambridgeshire (GB); Ruslan VAKHITOV, Hinxton Cambridgeshire (GB); Stanislav NIKOLSKIY, Hinxton Cambridgeshire (GB); Michael BURSELL, Hinxton Cambridgeshire (GB)

(73) Assignee: GENXT LTD, Hinxton Cambridgeshire (GB)

(21) Appl. No.: 19/113,696

(22) PCT Filed: Sep. 20, 2023
(86) PCT No.: PCT/IB2023/059311

§ 371 Date: Mar. 20, 2025

Related U.S. Application Data
(60) Provisional application No. 63/376,551, filed on Sep. 21, 2022.

(51) Int. Cl. H04L 9/40

(52) U.S. Cl. CPC H04L 63/0428; H04L 63/06; H04L 63/0807

(57) ABSTRACT

The present disclosures introduce a novel method allowing confidential computing to be performed within a federated environment, or systems of nodes, where nodes may grant permissions to other nodes or users to process their data using approved software without data or code disclosure. The method comprises a mechanism that introduces a mediator node that acts as an impartial entity, providing network discovery and network-level policy enforcement.

### CROSS-REFERENCE TO RELATED APPLICATIONS

This application claims priority to U.S. Provisional Application No. 63/376,551 filed Sep. 21, 2022, and entitled “Confidential Computing Network for Cross-Database DNA Relatives Matching”which has been incorporated herein in its entirety by reference.

### FIELD

The present disclosure generally relates to network security and confidential computing, and more specifically relates to federated systems leveraging trusted execution environments.

### BACKGROUND

In a digital environment, different entities (e.g., companies, businesses) collect and analyze data. Data collaboration leads to faster and more accurate decisions. However, in conventional computing systems, sharing data or code with another entity inherently causes an inability of the sharing entity to control further use of data or code by the receiving entity.

Confidential computing has emerged as an improved technology that addresses these issues by enabling hardware-enforced trust establishment between remote computing devices controlled by different entities. Leveraging such a trusted environment, confidential computing allows the entities to exchange data or code that cannot be accessed or modified outside the environment. Confidential computing technology therefore provides a new security primitive for the protection of data in use by performing computations in a hardware-based, isolated, and attested trusted execution environment (TEE).

Despite the superior level of security achieved by using TEEs, significant challenges remain for collaborating entities to perform network discovery and network-level authorization, and to exchange query messages, or statistics.

### SUMMARY

In some embodiments, a computer-implemented method may be provided. The method may include outputting, by a mediator node in a federated confidential computing network, a list of connected confidential computing nodes and corresponding network addresses such that a first confidential computing node in the federated confidential computing network discovers a second confidential computing node in the federated confidential computing network. The method may also include receiving, by the mediator node from the first confidential computing node, a permission request to communicate with the second confidential computing node. The method may further include providing, by the mediator node, a network level authorization to the first confidential computing node such that the first confidential computing node communicates with the second confidential computing node to execute a task.

In some embodiments, a computer-implemented method may be provided. The method may include receiving, by a first confidential computing node in a federated confidential computing network and from a mediator node, a list of connected confidential computing nodes and corresponding network addresses, the first confidential computing node executing a trusted execution environment. The method may also include transmitting, by the first confidential computing node to the mediator node, permission request for a task to communicate with a second confidential computing node in the federated confidential computing network. The method may further include receiving, by the first confidential computing node from the mediator node, a network level authorization; and transmitting, by the first confidential computing node to the second confidential computing node and based on the network level authorization, the request for the task such that the second confidential computing node executes the task in a corresponding trusted execution environment.

### BRIEF DESCRIPTION OF DRAWINGS

FIG. 1 shows an example system configured to implement a mediation methods for a federated confidential computing system, according to example embodiments of this disclosure.

FIG. 2 shows an example mutual attestation process, according to example embodiments of this disclosure.

FIG. 3 shows a process diagram of an example method of providing confidential data processing services between nodes, according to example embodiments of this disclosure.

FIG. 4 shows a process diagram of an example method of training a machine learning model in a confidential computing environment, according to example embodiments of this disclosure.

FIG. 5 shows a process diagram of an example method of training a machine learning model using federated learning in a confidential computing environment, according to example embodiments of this disclosure.

FIG. 6 is a flowchart of an example method of network discovery and authentication provided by a mediator node, according to example embodiments of this disclosure.

FIG. 7 is a flowchart of an example method a task execution in a federated confidential computing network, according to example embodiments of this disclosure.

### DETAILED DESCRIPTION

Embodiments disclosed herein describe mediation systems and methods within federated confidential computing environments. The mediation systems and methods provide a significant improvement over conventional federated computing systems. For example, conventional computing federated computing systems may not necessarily provide integrity and confidentiality protection of shared data or code. This lack of integrity and confidentiality results in an inability to track the usage of shared data and code and presents fundamental challenges in data privacy, security, and software licensing preservation. Additionally, if disparate systems associated with different entities are to be interconnected, such interconnection often necessitates a delegation of authority to a controlling mechanism within the interconnecting system. The embodiments disclosed herein provide functionality that solves these technical problems and may provide additional benefits.

The disclosed example federated confidential computing environment, also referred to as a federated confidential computing network or system, may include a plurality of confidential computing nodes, simply referred to as nodes. Each node may include a TEE-based system that is designed to leverage TEE's isolation and remote attestation mechanisms to establish trust among each other and also to provide confidentiality and integrity protection for computing operations. These nodes collectively form a federated environment, representing independent, autonomous entities that control their own computing resources and digital assets, including but not limited to processors, memory, databases, or software.

Nodes may be associated with different entities, e.g., a legal entity, stakeholder, an organization, a company, etc. The nodes may exchange and utilize resources from others as needed, and operate collaboratively as a unified system when required. In relation to data protection legislation (e.g., General Data Protection Regulation by the European Union), each node may be associated with an independent entity and may perform the roles of a data processor, data controller, or data custodian. Further details on nodes'functionality are provided below.

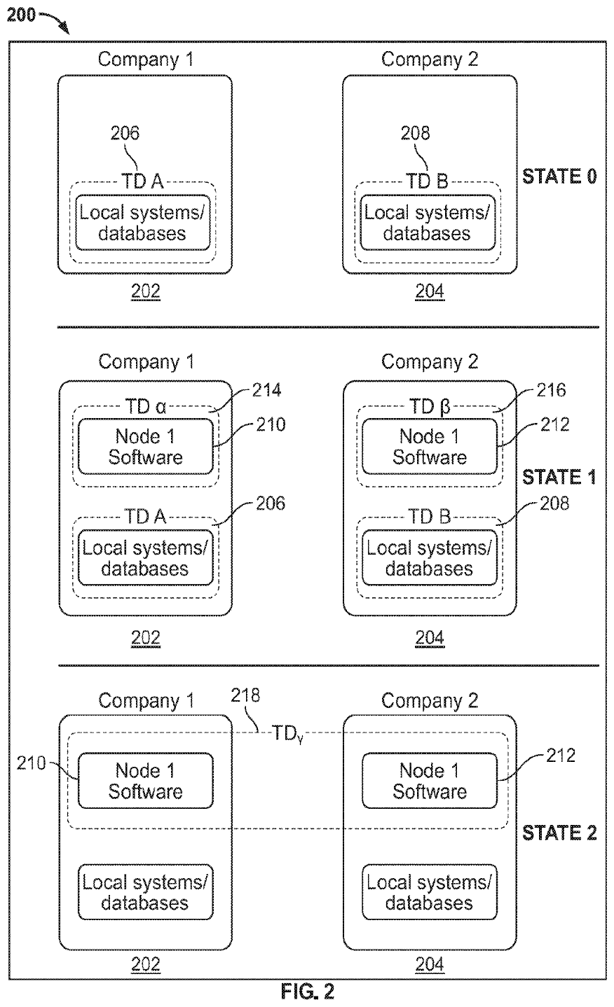

Embodiments disclosed herein also provide an approach that facilitates entities that their nodes within the federated confidential computing environment all are subject to the same set of policies in the context of data access and processing logic and thereby forming a single trust domain. This logic may embody the privacy-by-default concept, a principle that assures that any data processed by nodes are subject to the highest privacy settings by default, requiring explicit consent by the data owner. Additionally, and similarly to data consent preservation, this logic may implement preservation and enforcement of software licenses as permissions provided by the intellectual property rights holders to use their software tools within the federated confidential computing environment. The trust pivot required for the establishment of a single trust domain is achieved by the combination of preliminary node software audit that is performed by entities, and mutual verification that is performed by node instances using the TEE remote attestation. The audit may lead to the identification of trusted software versions, determined by hash sums or cryptographic signatures, that may be used for verification using the TEE remote attestation (e.g., as described in FIG. 2 below).

The mediation method may be implemented by a mediator node (also referred to as a mediator node and collectively as mediators) that may provide a collaborative computing environment for the nodes. The mediator node may provide the nodes with a minimally sufficient set of services necessary for authorized network connectivity, which comprises network discovery, authorization, and authentication services. In some embodiments, the mediator node may implement additional services including, but not limited to a task queue, query gateway, message broker, and collection of any type of statistics that may be agreed with the entities, or the TEE attestation service. The mediator node may be associated with a third-party mediation entity that facilitates the establishment of data processing relationships among entities associated with nodes by providing a legal and technical framework that may include instruments for negotiation, formation, management, and execution of data processing relationships within the federated confidential computing environment.

The communication of policies between collaborating entities and the mediation entity may be implemented in any form. In one embodiment, the mediator node may provide a web-based personal account or an application programming interface (API) that allows authorized entities'users or systems to control their collaboration policies. In some embodiments, nodes and the mediator node may leverage a blockchain ledger (e.g., permissioned blockchain) as a policy storage media, enhancing system integrity and security. Analogous to how a domain name service (DNS) server selectively points to IP addresses without actually hosting or passing through website content, mediator nodes in the federated confidential computing environment facilitate connections between nodes as well as ensure nodes'interactions with compliant network-level authorization. This approach may be employed by the mediator node to transform the need for individual entities to maintain multiple separate data sharing and/or processing agreements into a streamlined and compliant process. Given its legal role in the establishment of data processing relations, the mediator node may be accountable for the enforcement of nodes'collaboration policies. To fulfil this role, the mediator node may authorize network access between each pair of nodes only in the case of a mutually expressed data processing relationship. The possible authorization methods are described below. The mediator node, by design, may not have access or control over nodes'internal resources, digital assets, and related policies. Additionally, the mediator node may not be unable to compromise nodes'collaboration policies, as they may also implement appropriate network-level authorization checks along with the implementation of data privacy and software licensing permissions preservation. Embodiments disclosed herein facilitate integration without diminishing the self-governance of independent nodes within a federated environment.

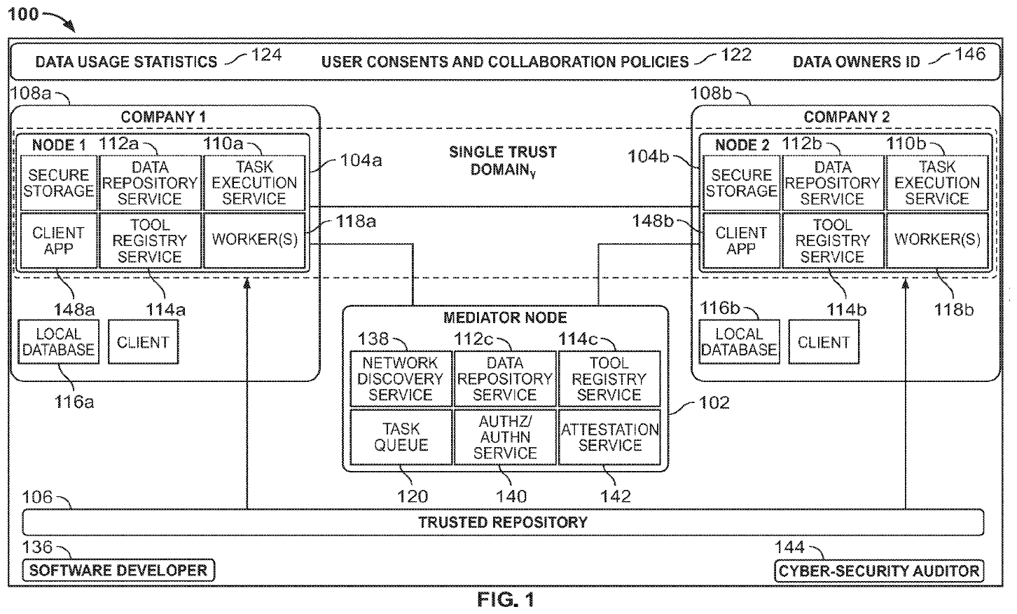

FIG. 1 shows an example system 100 configured to implement mediation methods for a federated confidential computing system, according to example embodiments of this disclosure. It should be understood that the components of the system 100 shown in FIG. 1 and described herein are merely examples and systems with additional, alternative, or fewer components should be considered within the scope of this disclosure. Furthermore, a single component does not necessarily mean that it is implemented in a single piece of hardware and/or software, multiple components may be used to implement a component or multiple components may be implemented on a single piece of hardware and/or software.

As shown, the system 100 may generally include a trusted repository 106, at least two confidential computing nodes 104a, 104b (collectively referred to as nodes 104 and commonly referred to as a node 104) forming a federated confidential computing system, and at least one mediator node 102. As shown, the node 104a may be associated with an entity 108a and the node 104b may be associated with entity 108b. Other shown components are described below.

Trusted repository 106 may refer to a storage medium storing software whose trustworthiness may have to be scrutinized and confirmed through an audit conducted by a particular entity or by one or more auditors such as an independent cybersecurity auditor 144 that is trusted by that entity. The term “trusted” should be understood in the context of a specific entity that serves as the subject of trust. The software that could be considered trusted may implement privacy-by-default data access logic to minimize the risk of data breaches. Source code audit checks may ensure that the software has no unexpected code (e.g., malware) or any other untrusted or vulnerable code. Each software, along with all of its versions, may be rigorously examined and tested by the cyber-security auditor 144, e.g., by subjecting the software to a series of security and behavioral checks. In some embodiments, the trustworthiness of the software may be determined by comparing the node software's hash sum or signature to a whitelist. It should be noted that at least one software version should be considered trusted by at least two entities to allow them to connect. In one embodiment, software in the mediator node 102 may implement additional services and can also become a required subject of audit. In some embodiments, the nodes 104 may dynamically load the trusted software.

Nodes 104 may be deployed from the trusted repository 106 by an entity personnel (e.g., a system administrator of entity 108a or 108b) or by automated script within the entity's infrastructure (e.g., software executing on the entity 108a or 108b). In some embodiments, node deployment may be initiated by a blockchain smart-contract.

The nodes 104 may provide node users and other nodes 104 with a number of services including but not limited to task execution services 110a, 110b (collectively referred to as task execution services 110 and commonly referred to as task execution service 110), data repository services 112a, 112b (collectively referred to as data repository services 112 and commonly referred to as a data repository service 112), and tool registry services 114a, 114b (collectively referred to as tool registry services 114 and commonly referred to as a tool registry service 114). It should be understood that the task execution services 110, data repository services 112, and tool registry services 114 may be functional domains that may be implemented either indirectly, or as independent, standalone modules. These services may be designed in a federated manner able to route inbound requests to interoperable services of other nodes 104 directly or through the mediator node 102 that may act as a query gateway or message broker.

The task execution service 110 may be a node 104 subsystem that may orchestrate the execution of tasks. A task may be a unit of computational work performed by the nodes 104, and described by a set of inputs, outputs, and a command to run. Task inputs may include links to datasets from the nodes 104. Task output may include standard software execution outputs provided by the employed operation system and optional metadata and logging provided by the task execution service 110. A command may be a node-in-built function or a separate software tool (e.g., any software including any kind of machine learning applications; hereinafter also referred to as a tool or a software tool. In some embodiments, the task execution service 110 may query for tasks in the node 104's local task queue or mediator node 102's task queue. Further details on task queue functionality are discussed below. To execute the tasks, the task execution service 110 may use workers 118a, 118b (collectively referred to as workers 118 or commonly referred to as a worker 118). In some embodiments, a task may be cryptographically signed by the initiating node 104 to ensure the authenticity of the task, verify that the task has not been altered in transit between nodes 104, or provide evidence that the initiating node 104 cannot later deny having initiated the task. In this embodiment, the task execution service 110 may verify the task's authenticity using its cryptographic signature and may reject the task if the authenticity cannot be verified.

The workers 118 may include a TEE-based subsystem of the node 104 that may execute the tasks. Workers 118 may be horizontally scaled when desired. In some embodiments, workers 118 may execute tasks in a sandbox environment (e.g., WebAssembly, Sandboxed Python, etc.) that may control the task's runtime behavior by enforcing a set of rules and restrictions (e.g., differential privacy) that may be in-built or configurable by node host or owner of the data requested for processing. For example, the sandbox environment facilitates filtering of computational results from executing the node software based on privacy policies associated with the nodes 104.

Nodes 104 may be connected with one or more local databases 116a, 116b (collectively referred to as local databases 116 and commonly referred to as a local database 116). The local databases 116 may include a separate storage medium that can be a database system, file storage, or a service which provides data upon request. Access permissions may be granted at the user level, and, if necessary, can be further specified for a particular software tool. All of these permission specifications are intended solely for execution or processing within the confines of the worker 118.

Nodes 104 may maintain a secure storage that may allow them to store datasets in an encrypted format and grant access to other nodes 104 in the federated confidential computing network. Secure storage may also be used for storing results received from workers 118. Secure storage may include functionality for dataset encryption upon data request. Encryption keys may be generated within the TEE and may only be available to the attested TEEs. Thus, encrypted datasets can only be decrypted within an authorized TEE-based software instance. In some embodiments, data in secure storage or the local database 116 may store datasets encrypted using an envelope encryption method. Envelope encryption may include encrypting a plain text dataset with a primary data key and then encrypting the data key with another user key that may be further provided for authorized processing inside attested TEE. In another embodiment, data may be encrypted using threshold encryption (also sometimes referred to as “M of N” encryption) such that access to the decrypted data requires authorization from multiple parties. Threshold encryption is a type of cryptographic scheme where decryption is possible only when a predefined number of parties combine their unique decryption keys. This mechanism provides enhanced security, as no single party can unilaterally decrypt the data. These are just example encryption algorithms, and any encryption algorithm or combination of encryption algorithms should be considered within the scope of this disclosure.

A task queue 120 may be a subsystem within the mediator node 102 (and/or a node 104). In the shown example, the task queue 120 is within the mediator node 102. The task queue 120 may maintain a task list with technical information such as task identification numbers, data and software usage statistics, and time stamps associated with various steps of the tasks. The task queue 120 may be implemented using any queuing format or protocol. The task queue 120 may support load distribution, background processing, and scheduling or prioritization of tasks. It should be understood that, as a privacy-preserving measure, the task queue 120 may not necessarily store personal information in the embodiments implementing the task queue 120 on the mediator node 102. Tasks can be added to the task queue 120 for execution and removed from the task queue 120 after the execution. Additionally, the task queue 120 may be monitored by the nodes 104 to determine if there are any outstanding tasks. In some embodiments, a blockchain may serve as an immutable record of all the tasks that have been queued and executed, and their respective outcomes. The blockchain embodiment may provide a transparent, tamper-proof record of task execution.

The data repository service 112 may be a subsystem within a node 104 that may provide privacy-preserving access to data in the corresponding local database 116, or perform the functionality of a query gateway routing a data request through connected mediator nodes (e.g., mediator node 102) or nodes 104. The data repository service 112 in a data controlling node 104 with private data, stored in the corresponding local database 116 may determine the legitimacy of data processing requests based on the consent. A consent may be a permission record created by a data owner (individual, organization, or group of the individuals or organizations, e.g., as associated with data owner's identification 146) that may specify which entities (individuals, organizations, or groups of the individuals or organizations) have permission to perform data processing identified by category or purpose on a dataset or a single record in the dataset. In some embodiments, the consent may specify which software tools are approved for processing the corresponding datasets (which may contain data at any structure with any amount of records). Approved software tools may be identified by a hash sum or cryptographic signatures. In some embodiments, the consents may be organized in a machine-readable consent registry. The consent registry may be stored in the local databases 116 or, in some embodiments, incorporate a blockchain ledger (e.g., public or permissioned blockchain), and may implement smart contracts to automate the verification and management of consent transactions. In some embodiments, the data repository service 112 may implement data usage tracking, which also may be implemented using blockchain with the use of smart-contracts to provide the tamper-proof record of data usage statistics 124.

The tool registry service 114 may be a subsystem (within the nodes 104 and/or the mediator node 102) that may maintain a list of tools that may run using the trusted execution services. The tool registry service 114 may include an interface for maintaining the list and provide the ability to tag tools (e.g., as trusted) by multiple users or organizations (e.g., cyber-security auditors). The tool registry service 114 may use the trusted repository 106 to store the tools. The tools may be associated with the corresponding software developer 136 (also referred to as intellectual property rights holder or maintainer). Although the software developer 136 may be allowed to upload various tools for data analysis, using the tool registry service 114 in coordination with the trusted repository 106 may facilitate that such upload flexibility may not damage the integrity of the operations in the nodes 104 or breach data privacy. In some embodiments, the tool registry service 114 may implement logic to maintain software dependencies and supply chains or use information about these to make decisions about the trust associated with particular versions or instantiations of the tools stored.

In some embodiments, tool registry service 114 may also maintain the licenses for different software tools given by the software developer 136 to specific entities 108, nodes 104, or node users. The licenses may specify terms including pricing and billing options, and may be publicly offered, to a specific group or category of entities (e.g., only for non-commercial use), or for a specific entity or individual. Each time a node 104 (which, as described above, may be any node within the federated confidential computing network) requests the use of the software on behalf of the node user, the tool registry service 114 verifies that the requester has an appropriate license. This verification may therefore avoid license breaches and preserve the digital rights of the software developer 136. The tool registry service 114 may store license permissions in a local storage 116 or blockchain and may provide the license permissions to other nodes 104, subsystems, or mediator nodes (e.g., the mediator node 102), as configured. In some embodiments, the tool registry service 114 may incorporate one or more blockchains to store license permissions or usage tracking and may leverage programmatic smart-contracts to ensure immutable automatization. In some embodiments, the tool registry service 114 may incorporate or provide an ability to connect external policy engines to retrieve or deliver information about license permissions or data usage statistics 124. The data usage statistics 124 may be used to implement billing.

A node 104 may provide access to its services via an API, web portal, or console interface (e.g., through client applications 148a, 148b). For instance, a node operator might manually request task execution on a local or remote node 104, and may supply an input dataset for the task's execution. Alternatively, within an organization's infrastructure associated with the node 104, a system may request task execution on a remote node 104 connected within the federated confidential computing network. This request may utilize the API provided by the organization's node 104. In some embodiments, the node 104 may include a multi-user system.

A node 104 may serve one or more users, who could represent a legal entity associated with the node 104, its personnel, a system, a customer, or any other third-party system, organization, or individual. For instance, a user might be an independent researcher, or a researcher associated with a specific research institution, interacting with a node 104 that is associated with a biobank.

In some embodiments, the nodes 104 may provide services for anonymous users. For example, users may check whether their passwords or payment credentials are compromised by querying relevant databases of leaked information. In this scenario, the user may The mediator node 102 may include a combination of software services performing the mediation functionality described throughout this disclosure. As shown, the mediator node 102 may comprise a network discovery service 138, a task queue 120, an authorization/authentication service 140, and the TEE attestation service 142. Using one or more of these components, the mediator node 102 may provide several network services, as further described below. It should, however, be understood that these components and the corresponding functionality are merely illustrative and should not be considered limiting.

Generally, the mediator node 102 may function as a hub that provides network discovery (e.g., by using the network discovery service 138) for connected nodes 104 allowing the nodes 104 to discover each other within the mediator node 102's network segment. The mediator node 102 may provide the nodes 104 with the task queue 120 allowing the nodes 104 to decouple the task submission from task execution. This decoupling may provide flexibility and scalability, as tasks can be processed asynchronously based on the availability of the target node 104 or other resources. Additionally, the mediator node 102 may facilitate that nodes 104 are executing genuine trusted applications (e.g., deployed from the trusted repository 106) by using the TEE remote attestation.

The authorization and authentication service 140 may authorize the nodes 104 and interactions between the nodes 104 within the system 100. The authorization and authentication service 140 may include a certificate authority (CA) service. Each new node 104 connecting to the network may be provided, by the mediator node 102, with unique virtual private network (VPN) credentials or any other certificates (e.g., revocable certificates) signed by the certificate authority service that may configure the node for network access. In some embodiments, for each task in the system 100, the authorization and authentication service 140 may generate a token (e.g., a ticket). Any interactions, data processing, requests, and/or any other functionality within a task life cycle may be possible only when there is a valid token provided. Tokens may be issued to authorize different actions in different contexts to provide multi-level authorization and authentication mechanisms. For example, a node 104 that receives the request from another node 104 may check the genuineness of the token at the authentication and authorization service 140. The use of tokens may also function as an exclusion mechanism: if a third-party user or an entity is to be excluded from the system 100, a token may not be issued to them or an existing token may be revoked. Any mechanism or protocol for authorization and/or authentication should be considered within the scope of this disclosure (e.g., Kerberos, OIDC, SAML; Keycloak; key management systems). This mechanism may be supported by the nodes 104, audited, expected by each collaborating entity and its node 104, and enforced by verifying node 104's genuineness with the mutual TEE Remote Attestation. Therefore, the mediation systems and methods may allow the establishment of a single trust domain within a set of federated confidential computing nodes controlled by different entities by providing that all the nodes 104 within the federated confidential computing environment are subject to the same set of policies in different contexts of data access and processing logic. Consequently, the authorization and authentication service 140 may allow only authorized parties to access the different parts of the system 100.

An example role of the authentication and authorization service 140 is to authorize network-level interactions between the nodes 104 based on the collaboration policies set by the nodes 104. In some embodiments, authentication and authorization service 140 may also function as a licensing server for software tools that may be executed on nodes 104.

In some embodiments, the mediator node 102 may implement additional services such as a query gateway or message broker that could serve for interconnecting the described system components (e.g., network discovery, authorization and authentication, task execution service, data repository service, tool registry service) across available federated confidential computing environment network segments. Requests or messages channeled through the additional services may be cryptographically signed by the originating system (e.g., node 104) to ensure the authenticity and integrity of the messages. This design may provide that the mediator node 102 cannot alter or tamper with these messages, preserving both the integrity and trustworthiness of the communication within the network.

As described above, the system 100 is an example, and additional system configurations are to be considered within the scope of this disclosure. In one embodiment, the mediator node 102 may be connected with other mediators for network expansion. Each of the multiple mediator nodes may be connected to a distinct federated confidential computing network. This can be implemented in complex cases of federated environments where multiple mediator nodes act as a hub for each independent network segment by providing cross-network discovery and message routing among the segments. Alternatively or additionally, the nodes may be connected to multiple mediator nodes. Therefore, different nodes across different federated confidential computing networks may have visibility of each other's resources.

In some embodiments, any set of described components may be implemented using a combination of microservices architecture, containerization, and orchestration platforms, such as Kubernetes clusters, to provide Byzantine fault tolerance. By leveraging these modular and scalable design principles, the system components may remain resilient and operational.

It should be noted that mediator and node system components may leverage any TEE systems such as Intel SGX, Intel TDX, AMD SEV-SNP, ARM TrustZone, NVIDIA Confidential Computing, or any other computing devices implementing the TEE. In some embodiments, different components may leverage different TEE systems.

In some embodiments, nodes 104 may support working with encrypted files received from a TEE-based device that performs the generation, transformation or acquisition of data. In some embodiments, such devices may implement one or more special file formats that incorporate credentials (e.g., cryptographic signature, any type of unique ID) of the device operator or data owner. These credentials may be used to enforce data usage consents. For example, a DNA sequencing machine may utilize a TEE-based processing chip to acquire raw data and streamline it in an encrypted format to secure storage. The encryption keys may be generated and delivered to the device from a node or TEE-based key management system implemented in a federated confidential computing system. The encrypted data may be used for authorized processing by providing decryption keys only to an authorized user for processing with a specific trusted software tool executed inside the attested TEE. This embodiment ensures data and privacy protection during the entire data life cycle.

FIG. 2 shows an example mutual attestation process 200, according to example embodiments of this disclosure. It should be understood that the shown attestation process 200 with three steps is just but an example and should not be considered limiting. That is attestation processes with additional, alternative, of fewer number of states should be considered within the scope of this disclosure.

At State_0, each of first node 202 (e.g., associated with a first entity) and a second node 204 (e.g., associated with a second entity) may have separate trust domains 206 (TD_A) and 208 (TD_B), respectively. Each of the trust domains 206, 208 may include local systems and/or databases.

At State_1, a first node software 210 may run to form a first trust domain 214 (TD_α) and a second node software 212 may run to form a second trust domain 216 (TD_β).

At State_2, a mutual attestation is performed such that the first node software 210 and the second node software may form a single trust domain 218 (TD_γ). The two nodes 202, 204 may now communication with each other through the single trust domain 218.

The nodes 202, 204 may generate and exchange encryption keys using a combination of cryptographic protocols, such as Diffie-Hellman, that may be integrated with remote attestation data. For instance, before initiating the exchange, each node 202, 204 may perform a remote attestation to obtain an attestation report or quote. This report, containing a unique measurement of a corresponding software, a signature, and a nonce for freshness, ensures the integrity and identity of the software running inside the TEE. The derived attestation data is then may be used in the key generation (e.g., as an ephemeral key). By combining cryptographic key exchange with remote attestation information, the nodes 202, 204 can achieve a higher level of trust, ensuring that that the nodes 202, 204 are not only communicating securely but also with genuine, untampered counterparts. The generated and shared key may be used to encrypt and securely transfer data or code to another node for authorized purposes. For example, data may be decrypted inside the TEE on one node (e.g., first node 202) and decrypted inside TEE on another node (e.g., second node 204) for authorized processing using software trusted by the data owner. Additionally, encrypted software images may be transferred, decrypted, and executed inside the nodes 202,204′ TEEs with the software developer's permission. These software images may be also subject to a software audit, and, in some embodiments, be executed in the TEE-protected sandbox environment implemented in the nodes 202, 204. It should be noted that the use of keys generated inside TEE and provided only to authorized TEEs ensures that data cannot be decrypted while temporarily or consistently stored in the storage of the receiving node. Therefore, interactions among the nodes 202, 204 may be implemented without breaching the integrity and confidentiality of data, code, queries, execution parameters, or computational results. This inherently secures the integrity of full control over nodes 202,204′s resources and digital assets and allows the minimization of data exposure to isolated and attested trusted software instances.

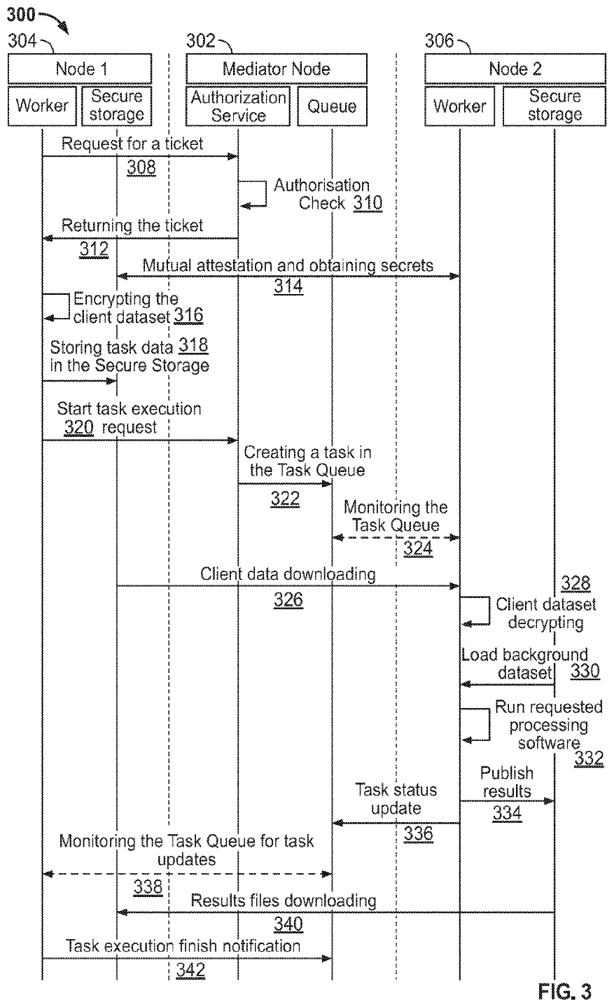

FIG. 3 shows a process diagram of an example method 300 of providing confidential data processing services between nodes, according to example embodiments of this disclosure. The shown steps of the method 300 are merely examples and should not be considered limiting. That is, methods with additional, alternative, of fewer number of steps should be considered within the scope of this disclosure.

In some embodiments, two or more nodes (as shown, a first node 304 and a second node 306) may provide confidential data processing services to each other using a mediator node 302. Such services may confidentially process input data (e.g., genomics, omics, medical, financial data) using locally available data as a training data set to provide any kind of prediction, inference, or interpretation services (e.g., disease prediction, genomic relatedness or ancestry composition analysis; credit score, etc.). Each of the first node 304 and the second node 306 may include a worker and a secure storage. The mediator node 302 may include an authorization service and a queue.

In the example method 300, the first node 304 (further referred to as an initiating node 304) at step 308 may request a task execution on the second node 306 (further referred to as the executing node 306). The task may include executing specific software to process data provided by the initiating node 304 within the data available in the local storage of the executing node 306. The mediator node may authorize node-to-node interactions by issuing and validating tickets (e.g., tokens) using the example steps described below.

At step 308, the initiating node 304 may transmit a request for a ticket to the mediator node 302, which may be utilized by the initiating node 304 in further interactions with the executing node 306 or the mediator node 302. The transmitted request may include data such as, but not limited to, the type of task, a list of nodes designated for task execution, and a link to input data required for task execution. At step 310, the mediator node 302 may perform an authorization check to validate whether the initiating node 304 is authorized to request the execution of specific types of tasks, and may further verify any additional information or data submitted along with the task.

At step 312, the mediator node 302 may send the requested ticket to the initiating node 304. When the initiating node 304 receives the ticket, the initiating node 304 is authorized to send a request to the executing node 306.

At step 314, the initiating node 304 and the executing node 306 may perform mutual attestation. At step 316, the initiating node 304 may encrypt a dataset from local storage inside the TEE using an ephemeral key generated inside the TEE. At step 318, the initiating node 304 may store the encrypted dataset secure storage of the initiating node 304. At this point, a link to the encrypted dataset may be accessible to executing node 306.

At step 320, the initiating node 304 may transmit a start task execution to the mediator node 302 indicating readiness for task execution. The request may include data such as, but not limited to, the type of task, a list of nodes designated for task execution, additional data that may be needed for task execution, the location of the stored dataset (e.g., the link), and/or other relevant information.

At step 322, the mediator node 302 may create a task in a task queue that is visible to the nodes specified by the initiating node 304. The mediator node 302 may also check the availability and permissions of the designated nodes for task execution, and further evaluate any constraints that may affect the ability of certain nodes to interact with others or process specific task types, datasets, or data classifications.

At step 324, the executing node 306 may monitor the task queue for available tasks. Upon detection of an available task, that executing node 306 may begin task execution, or alternatively postpone the execution if other tasks are currently being processed or if the executing node 306 is under maintenance.

To execute the task, the executing node at step 326 may retrieve the client dataset from the initiating node 304. The retrieval step 326 may include an establishment of a secure communication channel between the secure storage of the initiating node 304 and the processing environment of the executing node 306, which may be executed inside the TEE for data security.

At step 328, the executing node 306 may decrypt the client dataset retrieved at step 326. In scenarios where the task may require computation/processing of two datasets, the executing node 306 at step 330 may retrieve a background dataset from the local storage connected to the executing node 306 within the TEE-based execution environment of the executing node 306.

The executing node 306 may also download software for the execution of specific task types, along with any additional data or parameters as needed. The software may be deployed from a trusted repository. In one embodiment, the software may be executed in a sandbox environment.

At step 332, the executing node 306 may execute the downloaded software. At step 334, the executing node 306 may publish the results of the software execution in the associated secure storage. At step 336, the executing node 306 may communicate the status of the task to the mediator node 302, which may update the task status in the task queue. Additionally, at step 338, the initiating node 304 may be monitoring the task queue for the task updates.

Upon completion of execution, the executing node at step 340 may upload the resulting files to the secure storage of the initiating node 304. The executing node 306 may also check the result files for validity. Additionally, the executing node 306 may notify the mediator node that the task execution is completed.

Once the initiating node 304 has received all the result files or task resolution statuses (e.g., success or error) from the executing node 306, the initiating node 304 may evaluate the results and at step 342 communicate to the mediator node 306 that the task has been completed.

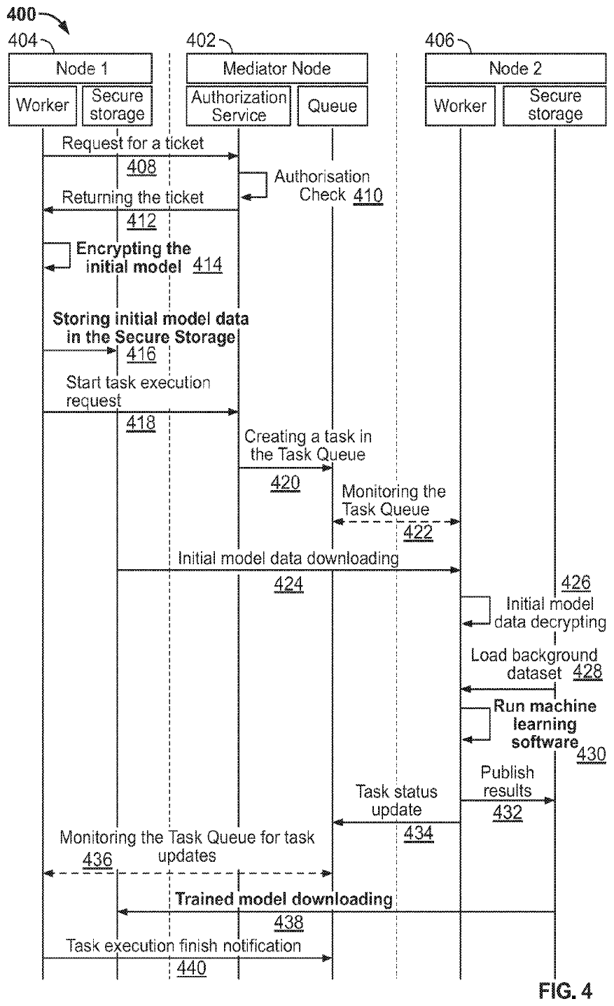

FIG. 4 shows a process diagram of an example method 400 of training a machine learning model in a confidential computing environment, according to example embodiments of this disclosure. The shown steps of the method 400 are merely examples and should not be considered limiting. That is, methods with additional, alternative, of fewer number of steps should be considered within the scope of this disclosure.

The nodes in the confidential computing network may be used to run tools that implement different types of machine learning models. For instance, one node may initiate training of a machine leaning model on the same or another node. The initiating node may retrieve a trained machine learning model without revealing it or the model code to any other node.

In the example method 400, a first node 404 (further referred to as an initiating node 404) may use a second node 406 (further referred to as an executing node 406) to train a machine learning model through a mediator node 402. As described in the steps below, the initiating node 404 may initialize the machine learning model and the executing node 406 may train the machine learning model using a data securely accessible by the executing node 406. While the initiating node 404 receives a trained machine learning model, the initiating node 404 does not have access to the data used for training the machine learning model. As shown, each of the initiating node 404 and the executing node 406 may include a worker and a secure storage, and the mediator node 402 may include an authorization service and a queue.

At step 408, the initiating node 404 may transmit a request for a ticket to the mediator node 402, which may be utilized by the initiating node 404 in further interactions with the executing node 406 or the mediator node 402. The transmitted request may include data such as, but not limited to, the type of task (e.g., training the machine learning model), a list of nodes designated for task execution, and a link for downloading the machine learning model to be trained. At step 410, the mediator node 402 may perform an authorization check to validate whether the initiating node 404 is authorized to request the execution of specific types of tasks (i.e., to train the machine learning model), and may further verify any additional information or data submitted along with the task.

At step 412, the mediator node 402 may send the requested ticket to the initiating node 404. When the initiating node 404 receives the ticket, the initiating node 404 is authorized to send a request to the executing node 406.

The initiator node 404 may then generate an initial machine learning model. At step 414, the initiator node 404 may encrypt the initial machine learning model. At step 416, the initiator node may store the encrypted initial machine learning model at the secure store of the initiator node as an initial model data.

At step 418, the initiating node 404 may transmit a start task execution to the mediator node 402 indicating readiness for task execution (i.e., training the machine learning model). The request may include data such as, but not limited to, the type of task (i.e., training the machine learning model), a list of nodes designated for task execution, additional data that may be needed for task execution, the location of the stored initial model data, and/or other relevant information.

At step 420, the mediator node 402 may create a task in a task queue that is visible to the nodes specified by the initiating node 404. The mediator node 402 may also check the availability and permissions of the designated nodes for task execution (i.e., training the machine learning model), and further evaluate any constraints that may affect the ability of certain nodes to interact with others or process specific task types, datasets, or data classifications.

At step 422, the executing node 406 may monitor the task queue for available tasks. Upon detection of an available task (i.e., training the machine learning model), the executing node 406 may begin task execution, or alternatively postpone the execution if other tasks are currently being processed or if the executing node 406 is under maintenance.

To execute the task of training the machine learning model, the executing node 406 at step 424 may retrieve the initial model data from the initiating node 404. The retrieval step 424 may include an establishment of a secure communication channel between the secure storage of the initiating node 404 and the processing environment of the executing node 406, which may be executed inside the TEE for data security.

At step 426, the executing node 406 may decrypt the initial model data retrieved at step 424. At step 428, the executing node 406 may load background dataset from the associated secure storage for training the machine learning model. Additionally, the executing node 406 may download machine learning software, along with any additional data or parameters as needed. The machine learning software may be deployed from a trusted repository. In one embodiment, the machine learning software may be executed in a sandbox environment.

At step 430, the executing node 406 may run the machine learning software to train the initial machine learning model (i.e., through the initial model data). At step 432, the executing node may publish the results of the training to the associated secure storage. At step 434, the executing node 406 may communicate the status of the task to the mediator node 402, which may update the task status in the task queue. Additionally, at step 436, the initiating node 404 may be monitoring the task queue for the task updates.

Upon completion of training, the executing node at step 438 may upload the trained model to the secure storage of the initiating node 404. The executing node 406 may also check the result files for validity (e.g., if the training parameters were met). Additionally, the executing node 406 may notify the mediator node 402 that the training has been completed.

Once the initiating node 404 has received the trained machine learning model, the initiating node 404 may evaluate the trained machine learning model and at step 440 communicate to the mediator node 402 that the task execution (i.e., to train the machine learning model) has been completed.

In one example of operations, the system may be used for executing federated learning workflows to train machine learning models on datasets stored on a number of nodes. In this setup, one node may initiate the workflow by executing a task with a central model, and then request an execution of federated edge models on two or more other nodes within the federated confidential computing system. Selected nodes may execute these edge models with access to their training datasets. All the nodes in the workflow scenario may establish end-to-end communication channels (e.g., SSL/TSL, RPC, gRPC) encrypted using ephemeral keys generated inside TEEs, so the communications cannot be tampered with from the outside. The training process may comprise a number of rounds (training epochs) and culminate in the generation of an aggregated central machine learning model effectively trained on data from all the participating nodes. The scenario may allow the machine learning model to benefit from the collective information of all datasets that belong to the participating nodes without the need for moving data and exposing individual data from each node. This embodiment extends its protective measures beyond the data, also ensuring the security of the machine learning model itself.

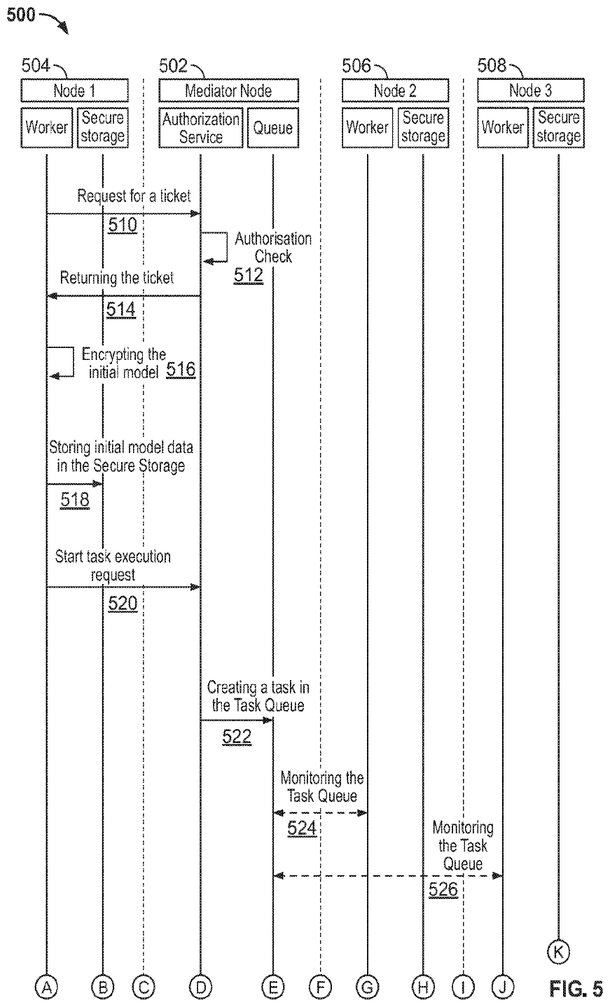

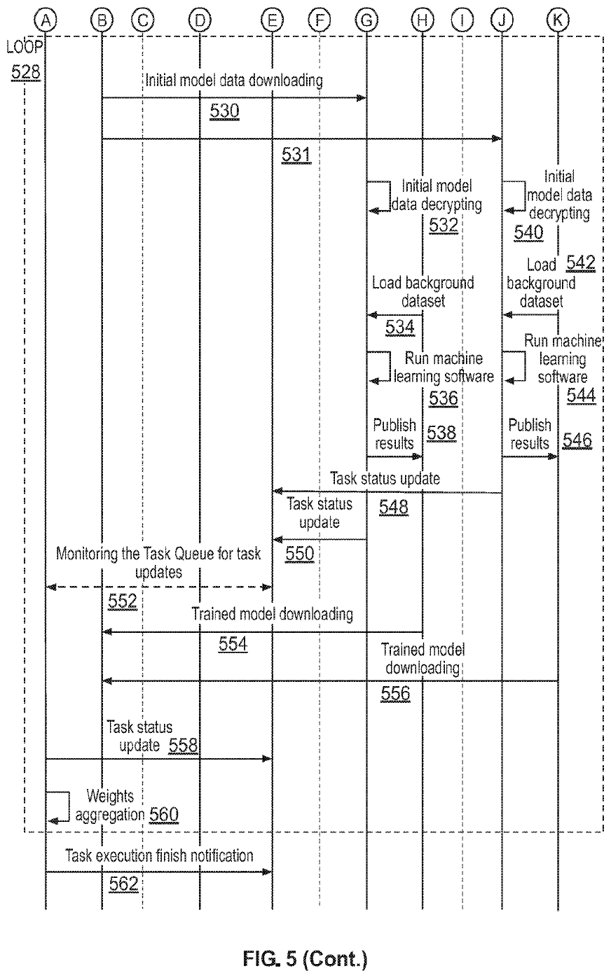

FIG. 5 shows a process diagram of an example method of 500 training a machine learning model using federated learning in a confidential computing environment, according to example embodiments of this disclosure. The shown steps of the method 500 are merely examples and should not be considered limiting. That is, methods with additional, alternative, of fewer number of steps should be considered within the scope of this disclosure.

In the example method 500, a first node 504 (further referred to as an initiating node 504) may use a second node 506 (further referred to as a first executing node 506) and a third node 508 (further referred to as a second executing node 508) to train a machine learning model through a mediator node 502 and using federated learning. As described in the steps below, the initiating node 504 may initialize the machine learning model and the first and second executing nodes 506, 508 may train the machine learning model using their corresponding accessible secure data. While the initiating node 504 receives a trained machine learning model, the initiating node 504 does not have access to the data used for training the machine learning model. As shown, each of the initiating node 504, the first executing node 506, and the second executing node 508 may include a worker and a secure storage, and the mediator node 502 may include an authorization service and a queue.

At step 510, the initiating node 504 may transmit a request for a ticket to the mediator node 502, which may be utilized by the initiating node 504 in further interactions with the executing nodes 506, 508 or the mediator node 502. The transmitted request may include data such as, but not limited to, the type of task (e.g., training the machine learning model), a list of nodes designated for task execution (e.g., executing nodes 506,508), and a link for downloading the machine learning model to be trained. At step 512, the mediator node 502 may perform an authorization check to validate whether the initiating node 504 is authorized to request the execution of specific types of tasks (i.e., to train the machine learning model), and may further verify any additional information or data submitted along with the task.

At step 514, the mediator node 502 may send the requested ticket to the initiating node 504. When the initiating node 504 receives the ticket, the initiating node 504 is authorized to send a request to the executing nodes 506, 508.

The initiator node 504 may then generate an initial machine learning model. At step 516, the initiator node 504 may encrypt the initial machine learning model. At step 518, the initiator node 504 may store the encrypted initial machine learning model at the secure store of the initiator node 504 as an initial model data.

At step 520, the initiating node 504 may transmit a start task execution to the mediator node 502 indicating readiness for task execution (i.e., training the machine learning model). 19 The request may include data such as, but not limited to, the type of task (i.e., training the machine learning model), a list of nodes (e.g., executing nodes 506, 508) designated for task execution, additional data that may be needed for task execution, the location of the stored initial model data, and/or other relevant information.

At step 522, the mediator node 504 may create a task in a task queue that is visible to the nodes (e.g., executing nodes 506,508) specified by the initiating node 504. The mediator node 502 may also check the availability and permissions of the designated nodes for task execution (i.e., training the machine learning model), and further evaluate any constraints that may affect the ability of certain nodes to interact with others or process specific task types, datasets, or data classifications.

At step 524, the first executing node 506 may monitor the task queue for available tasks. Additionally, at step 526, the second executing node 508 may monitor the task queue for the available tasks. Upon detection of an available task (i.e., training the machine learning model), both the executing nodes 506, 508 may begin task execution, or alternatively postpone the execution if other tasks are currently being processed or if the executing nodes 506, 508 are under maintenance. As further described below, the task execution may be in a loop 528.

To execute the task of training the machine learning model in the loop 528, the first executing node 506 at step 530 may retrieve the initial model data from the initiating node 504. The retrieval step 530 may include an establishment of a secure communication channel between the secure storage of the initiating node 504 and the processing environment of the executing node 506, which may be executed inside the TEE for data security.

Continuing with the first executing node 506, at step 532, the first executing node 506 may decrypt the initial model data retrieved at step 530. At step 534, the first executing node 506 may load background dataset from the associated secure storage for training the machine learning model. Additionally, the first executing node 506 may download machine learning software, along with any additional data or parameters as needed. The machine learning software may be deployed from a trusted repository. In one embodiment, the machine learning software may be executed in a sandbox environment.

At step 536, the first executing node 506 may run the machine learning software to train the initial machine learning model (i.e., through the initial model data). At step 538, the first executing node may publish the results of the training to the associated secure storage. At step 550, the first executing node 506 may communicate the status of the task to the mediator node 502, which may update the task status in the task queue. Additionally, at step 552, the initiating node 504 may be monitoring the task queue for the task updates.

The above training steps executed by the first executing node 506 may form a first epoch of training. The second executing node 508 may perform its own training forming a second epoch of training. The first and second epochs may be performed in parallel, sequentially, or in a random order. For the second epoch of training, at step 531, the second executing model 508 may download the initial model data. At step 540, the second executing node 508 may decrypt the initial model data retrieved at step 531. At step 542, the second executing node 508 may load background dataset from the associated secure storage for training the machine learning model. Additionally, the second executing node 508 may download machine learning software, along with any additional data or parameters as needed. The machine learning software may be deployed from a trusted repository. In one embodiment, the machine learning software may be executed in a sandbox environment.

At step 544, the second executing node 508 may run the machine learning software to train the initial machine learning model (i.e., through the initial model data). At step 546, the second executing node 508 may publish the results of the training to the associated secure storage. At step 548, the first executing node 506 may communicate the status of the task to the mediator node 502, which may update the task status in the task queue. Additionally, at step 552, the initiating node 504 may be monitoring the task queue for the task updates, as described above.

Upon completion of training, the first executing node 506 at step 554 may upload the trained model to the secure storage of the initiating node 504. Similarly at step 556, the second executing node 508 at step 508 upload the trained model to the secure storage of the initiating node 508. The executing nodes 506, 508 may also check the result files for validity (e.g., if the training parameters were met). Additionally, the executing nodes 506,508 may notify the mediator node 502 that the training has been completed.

Once the initiating node 504 has received the trained machine learning models from both the first executing node 506 and the second executing node 508, the initiating node 504 may at step 560 may perform weights aggregation. The initiating node 504 may further evaluate the trained machine learning model (e.g., with the aggregated weights) and at step 562 communicate to the mediator node 502 that the task execution (i.e., to train the machine learning model) has been completed.

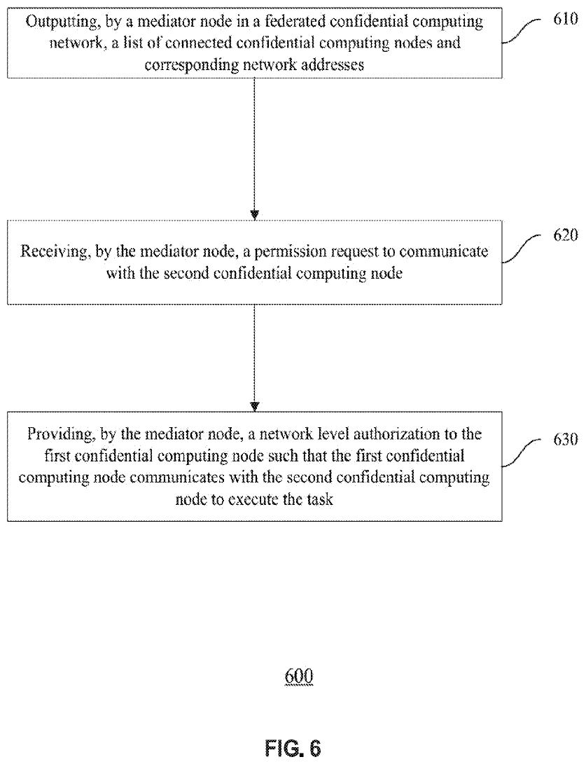

FIG. 6 is a flowchart of an example method 600 of network discovery and authentication provided by a mediator node, according to example embodiments of this disclosure. The shown steps of the method 600 are merely examples and should not be considered limiting. That is, methods with additional, alternative, of fewer number of steps should be considered within the scope of this disclosure. In some embodiments, the steps of the method 600 may be performed by a mediator node in a federated confidential computing network.

At step 610, a mediator node may output a list of connected confidential computing nodes and corresponding network addresses. Using the outputted list, a first confidential computing node in the federated confidential computing network may discover a second confidential computing node in the federated confidential computing network.

At step 620, the second confidential computing node may receive a request for a task from the first confidential computing node. The requested task may have to be executed by the second confidential computing node.

At step 630, the mediator node may provide a network level authorization to the first confidential computing node. The network level authorization may allow the first confidential computing node to communicate with the second confidential computing node to execute the task.

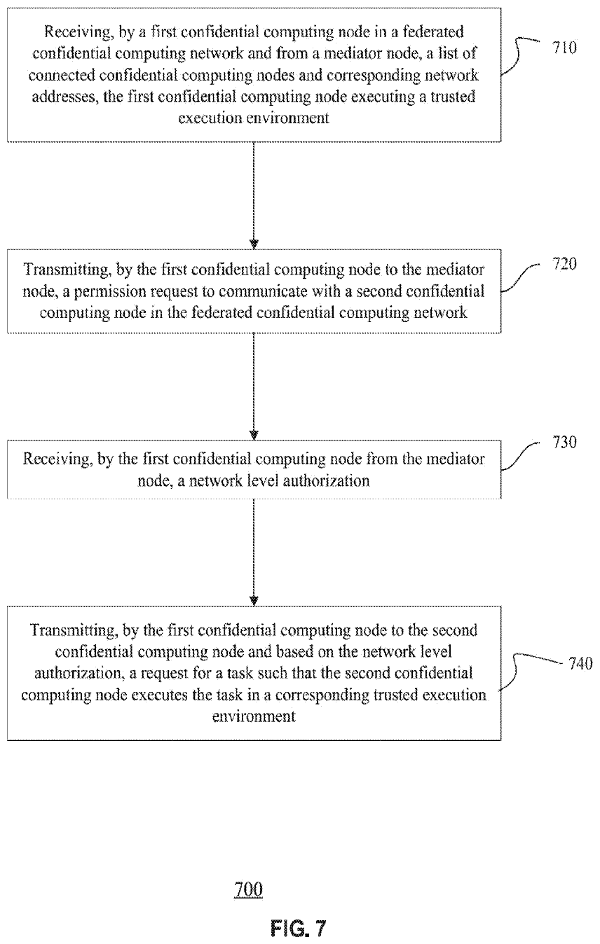

FIG. 7 is a flowchart of an example method 700 a task execution in a federated confidential computing network, according to example embodiments of this disclosure. The shown steps of the method 700 are merely examples and should not be considered limiting. That is, methods with additional, alternative, of fewer number of steps should be considered within the scope of this disclosure.

At step 710, a by a first confidential computing node in a federated confidential computing network may receive a list of connected confidential computing nodes and corresponding network addresses from a mediator node.

At step 720, the first confidential computing node may transmit to the mediator node, a permission request to communicate with a second confidential computing node in the federated confidential computing network.

At step 730, the first confidential computing node may receive a network level authorization from the mediator node to send a request for the task to the second confidential computing node.

At step 740, the first confidential computing node may transmit the request for the task to the second confidential computing node based on the network level authorization. The second confidential computing node may execute the task in a corresponding trusted execution environment.

Additional examples of the presently described method and device embodiments are suggested according to the structures and techniques described herein. Other non-limiting examples may be configured to operate separately or can be combined in any permutation or combination with any one or more of the other examples provided above or throughout the present disclosure.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

It should be noted that the terms “including” and “comprising” should be interpreted as meaning “including, but not limited to”. If not already set forth explicitly in the claims, the term “a” should be interpreted as “at least one” and “the”, “said”, etc. should be interpreted as “the at least one”, “said at least one”, etc. Furthermore, it is the Applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A computer-implemented method comprising:
outputting, by a mediator node in a federated confidential computing network, a list of connected confidential computing nodes and corresponding network addresses such that a first confidential computing node in the federated confidential computing network discovers a second confidential computing node in the federated confidential computing network;
receiving, by the mediator node from the first confidential computing node, a permission request to communicate with the second confidential computing node; and
providing, by the mediator node, a network level authorization to the first confidential computing node such that the first confidential computing node communicates with the second confidential computing node to execute a task.

2. The computer-implemented method of claim 1, wherein the task comprises at least one of a software execution request, data processing request, request for training a machine learning model, or request for training a federated machine learning model.

3. The computer-implemented method of claim 2, further comprising:
encrypting at least one of data associated with the data processing request, an initial model associated with the request for training the machine learning model, an initial model associated with the request for training the federated machine learning model using envelope encryption or threshold encryption.

4. The computer-implemented method of claim 1, the providing of the network level authorization comprising:
issuing, by the mediator node, a token to the first confidential computing node.

5. The computer-implemented method of claim 1, the providing of the network level authorization comprising:
validating, by the mediator node, a token received from the first confidential computing node.

6. The computer-implemented method of claim 1, the providing of the network level authorization comprising:
providing, by the mediator node, the network level authorization based on pre-established policies by at least one of the first confidential computing node or the second confidential computing node.

7. The computer-implemented method of claim 1, further comprising:
connecting, by the mediator node, to a second mediator node connected to additional confidential computing nodes such that the first confidential computing node discovers a third confidential computing node within the additional confidential computing nodes.

8. The computer-implemented method of claim 1, further comprising:
appending, by the mediator node, the request for the task to a task queue maintained by the mediator node.

9. The computer-implemented method of claim 8, further comprising:
facilitating, by the mediator node, the second confidential computing node to monitor the task queue.

10. The computer-implemented method of claim 9, further comprising:
providing, by the mediator node, the request for the task to the second confidential computing node.

11. The computer-implemented method of claim 10, further comprising:
receiving, by the mediator node from the second confidential computing node, a status update that the request for the task has been completed; and
removing, by the mediator node, the request for the task from the task queue responsive to receiving the status update.

12. The computer-implemented method of claim 10, further comprising:
receiving, by the mediator node from the first confidential computing node, a status update that the request for the task has been completed; and
removing, by the mediator node, the request for the task from the task queue responsive to receiving the status update.

13. The computer-implemented method of claim 1, further comprising:
collecting, by the mediator node, usage statistics associated with the request for the task.

14. The computer-implemented method of claim 10, further comprising:
storing, by the mediator node, the collected usage statistics to a blockchain.

15. The computer-implemented method of claim 1, wherein the request for the task is to be serviced by the second confidential computing node and a third confidential computing node of the federated confidential computing network, the providing of the network level authorization comprising:
providing, by the mediator node, the network level authorization to the first confidential computing node such that the first confidential computing node communicates with the second confidential computing node and the third confidential computing node to service the request for the task.

16. A computer-implemented method comprising:
receiving, by a first confidential computing node in a federated confidential computing network and from a mediator node, a list of connected confidential computing nodes and corresponding network addresses, the first confidential computing node executing a trusted execution environment;
transmitting, by the first confidential computing node to the mediator node, a permission request to communicate with a second confidential computing node in the federated confidential computing network;
receiving, by the first confidential computing node from the mediator node, a network level authorization; and
transmitting, by the first confidential computing node to the second confidential computing node and based on the network level authorization, a request for a task such that the second confidential computing node executes the task in a corresponding trusted execution environment.

17. The computer-implemented method of claim 16, wherein the task comprises at least one of a software execution request, data processing request, a request for training a machine learning model, or a request for training a federated machine learning model.

18. The computer-implemented method of claim 17, further comprising:
encrypting, by the first confidential computing node, at least one of data associated with the data request, an initial model associated with the request for training the machine learning model, an initial model associated with the request for training the federated machine learning model using envelope encryption or threshold encryption.

19. The computer-implemented method of claim 17, further comprising:
encrypting, by the first confidential computing node, at least one of data associated with the task using an ephemeral key generated inside the trusted execution environment.

20. The computer-implemented method of claim 16, further comprising:
establishing, by the first confidential computing node, a trustworthiness of a node software based on a source code audit; and
executing, by the first confidential computing node, the node software in the trusted execution environment.

21. The computer-implemented method of claim 20, the establishing of the trustworthiness of the node software comprising:
establishing, by the first confidential computing node, the trustworthiness of the node software based on the source code audit by a third-party auditor.

22. The computer-implemented method of claim 20, further comprising:
dynamically loading, by the first confidential computing node, the node software.

23. The computer-implemented method of claim 22, further comprising:
establishing, by the first confidential computing node, the trustworthiness of the node software by comparing the node software's hash sum or signature to a whitelist.

24. The computer-implemented method of claim 20, further comprising:
executing, by the first confidential computing node, the node software in a sandbox environment.

25. The computer-implemented method of claim 24, further comprising:
filtering, by the sandbox environment, computational results of from executing the node software based on privacy policies associated with the first confidential computing node.

26. The computer-implemented method of claim 16, further comprising:
verifying, by the first confidential computing node, a trustworthiness of the second confidential computing node by using the trusted executing environment remote attestation; and
transmitting, by the first confidential computing node to the second confidential computing node, the request for the task in response to the verification.

27. The computer-implemented method of claim 26, further comprising:
establishing, by the first confidential computing node with the second confidential computing node by using a key generated using the trusted executing environment remote attestation.

28. The computer-implemented method of claim 16, wherein the first confidential computing node is associated with a legal entity performing a role comprising at least one of a data controller, a data custodian, a data processor, or a data owner.

29. The computer-implemented method of claim 16, wherein the first confidential computing node comprises a local storage.

30. The computer-implemented method of claim 16, wherein the first confidential computing node comprises a multi-user system.
